(19) United States
(12) Patent Application Publication
(10) Pub. No.: US 2023/0023264 A1
(43) Pub. Date: Jan. 26, 2023

(54) COLLATION DEVICE, DEPOSIT SYSTEM, COLLATION METHOD, AND PROGRAM RECORDING MEDIUM

(71) Applicant: NEC Corporation, Minato-ku, Tokyo (JP)

(72) Inventor: Yuuichi AKAIKE, Tokyo (JP)

(73) Assignee: NEC Corporation, Minato-ku, Tokyo (JP)

(21) Appl. No.: 17/787,813

(22) PCT Filed: Dec. 25, 2019
(86) PCT No.: PCT/JP2019/050867

§ 371 Date: Jun. 21, 2022

(51) Int. Cl. G06F 16/51; G06F 16/583

(52) U.S. Cl. CPC G06F 16/51; G06F 16/583

(57) ABSTRACT

According to the present invention, in order to collate, without marking in advance, whether each container is a container to be deposited when collecting the container, this collation device is provided with: an object fingerprint database in which object fingerprint data extracted from image data of a product to be deposited is conserved; an object fingerprint data acquisition unit which acquires object fingerprint extracted from image data of the container; an object fingerprint data collation unit which collates the object fingerprint data extracted from the container image data with the object fingerprint data stored in the object fingerprint database, and generates deposit information according to the collation result; and a deposit information output unit which outputs, to an output source of object fingerprint data, the deposit information generated by the object fingerprint data collation unit.

### TECHNICAL FIELD

The present invention relates to a collation device or the like that performs individual collation using an object fingerprint.

### BACKGROUND ART

There is a mechanism in which a deposit is added to a sales price of a product and the deposit is returned at the time of collecting the empty container in order to prevent scattering of the empty container of the packaged product such as a PET bottle or a can sold by a vending machine or the like and promote recycling and reuse. However, at the time of collecting the empty container, if it is not possible to determine which vending machine sold the product to whose empty container belongs, there is a possibility that the deposit is defrauded.

PTL 1 discloses a method of identifying a store by a seal attached to an empty can, and returning a deposit based on the identified result.

PTL 2 discloses a container collecting device that detects light emitted from an identification mark by a non-visible paint attached in advance to a container, and returns a deposit when the identification mark is detected from the container.

### CITATION LIST

### Patent Literature

[PTL 1] JP S61-022296 U

[PTL 2] JP 2001-109930 A

### SUMMARY OF INVENTION

### Technical Problem

According to the method of PTL 1, it is possible to identify a store of an individual product at the time of returning a deposit by attaching a seal to the individual product in advance. However, the technique of PTL 1 has a problem in that it takes time and effort to attach a seal to each product in advance.

According to the method of PTL 2, by applying an identification mark to each product in advance with invisible paint, each product can be identified at the time of return of the deposit. However, the method of PTL 2 requires an ultraviolet lamp, an optical sensor, and the like for reading the identification mark applied to each product with invisible paint at the time of selling the product or collecting the container of the product.

An object of the present invention is to provide a collation device capable of collating whether each container is a deposit target without providing a mark in advance.

### Solution to Problem

A collation device according to one aspect of the present invention includes an object fingerprint database in which object fingerprint data extracted from image data of a deposit target product is stored, an object fingerprint data acquisition unit configured to acquire the object fingerprint data extracted from image data of a container, an object fingerprint data collation unit configured to collate the object fingerprint data extracted from the image data of the container with the object fingerprint data stored in the object fingerprint database and generate deposit information according to a collation result, and a deposit information output unit configured to output the deposit information generated by the object fingerprint data collation unit to an output source of the object fingerprint data.

In a collation method according to one aspect of the present invention, a computer is configured to execute acquiring object fingerprint data extracted from image data of a container, collating the extracted object fingerprint data with object fingerprint data stored in an object fingerprint database by referring to the object fingerprint database in which the object fingerprint data is stored, the object fingerprint data being extracted from image data of a deposit target product, generating deposit information according to a collation result, and outputting deposit information to an output source of the object fingerprint data.

A program according to one aspect of the present invention is for causing a computer to execute acquiring object fingerprint data extracted from image data of a container, collating the extracted object fingerprint data with object fingerprint data stored in an object fingerprint database by referring to the object fingerprint database in which the object fingerprint data is stored, the object fingerprint data being extracted from image data of a deposit target product, generating deposit information according to a collation result, and outputting deposit information to an output source of the object fingerprint data.

### Advantageous Effects of Invention

According to the present invention, it is possible to provide a collation device capable of collating whether each container is a deposit target without providing a mark in advance.

### BRIEF DESCRIPTION OF DRAWINGS

FIG. 1 is a block diagram illustrating an example of a configuration of a deposit system of the present example embodiment.

FIG. 2 is a block diagram illustrating an example of a configuration of a vending machine included in the deposit system of the present example embodiment.

FIG. 3 is a block diagram illustrating an example of a configuration of a collation device included in the deposit system of the present example embodiment.

FIG. 4 is a table illustrating an example of a collation table stored in a database by the collation device included in the deposit system of the present example embodiment.

FIG. 5 is a table illustrating another example of the collation table stored in the database by the collation device included in the deposit system of the present example embodiment.

FIG. 6 is a table illustrating still another example of the collation table stored in the database by the collation device included in the deposit system of the present example embodiment.

FIG. 7 is a block diagram illustrating an example of a configuration of a collecting machine included in the deposit system of the present example embodiment.

FIG. 8 is a flowchart for explaining an example of an operation at the time of selling a product of the vending machine included in the deposit system of the present example embodiment.

FIG. 9 is a flowchart for explaining an example of an operation at the time of selling a product of the collation device included in the deposit system of the present example embodiment.

FIG. 10 is a flowchart for describing an example of an operation at the time of collecting a container of the collecting machine included in the deposit system of the present example embodiment.

FIG. 11 is a flowchart for explaining an example of an operation at the time of collecting the container of the collation device included in the deposit system of the present example embodiment.

FIG. 12 is a block diagram illustrating an example of a configuration of a deposit system of Application Example 1.

FIG. 13 is a block diagram illustrating an example of a configuration of a deposit system of Application Example 2.

FIG. 14 is a block diagram illustrating an example of a hardware configuration that achieves processing by the deposit system of the present example embodiment.

### EXAMPLE EMBODIMENT

Hereinafter, embodiments of the present invention will be described with reference to the drawings. In all the drawings used in the following description of the example embodiment, the same reference numerals are given to the same parts unless there is a particular reason. Further, in the following example embodiments, repeated descriptions of similar configurations and operations may be omitted.

First, a deposit system according to an example embodiment of the present invention will be described with reference to the drawings. The deposit system of the present example embodiment focuses on the fact that fine patterns on the surface of products are different for each individual product, even in an industrial product that is uniformly manufactured. Hereinafter, the fine pattern on the surface is referred to as an object fingerprint. The deposit system of the present example embodiment extracts an object fingerprint for each individual of the container of the product, and identifies each individual container using the extracted object fingerprint. In the present example embodiment, when a packaged product (hereinafter, also referred to as a product) sold from a vending machine or the like is sold, object fingerprint data of a container of an individual product is stored in a database, and a deposit is added to the container. Then, when the object fingerprint data of the container is registered in the database at the time of collecting the container, the deposit system of the present example embodiment returns the deposit of the container. Note that the deposit system of the present example embodiment may be applied not to a form in which a deposit is added to a sales amount of a product but to a form in which a reward corresponding to collection of a container is paid.

(Configuration)

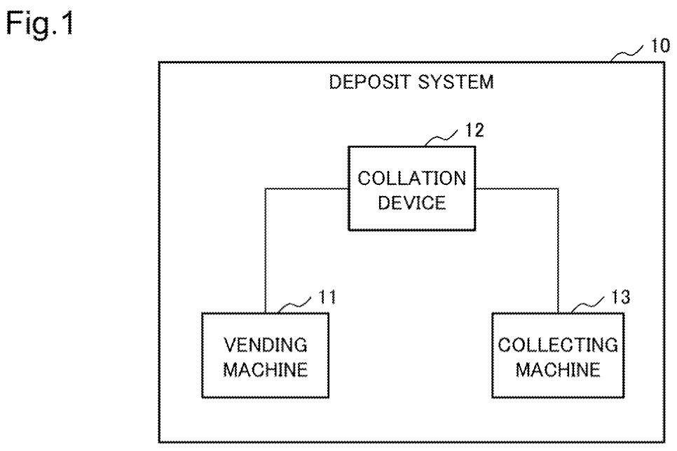

FIG. 1 is a block diagram illustrating an example of a configuration of a deposit system 10 of the present example embodiment. The deposit system 10 includes a vending machine 11, a collation device 12, and a collecting machine 13. The vending machine 11, the collation device 12, and the collecting machine 13 may be configured in the same housing, or may be configured in different housings. For example, the collation device 12 may be configured as a server by arranging the vending machine 11 and the collecting machine 13 side by side. In addition, a plurality of deposit systems 10 in which the vending machine 11, the collation device 12, and the collecting machine 13 are configured in the same housing may be provided, and a management server (not illustrated) that integrally manages the deposit systems 10 may be provided on a server or a cloud. In the present example embodiment, an example in which the deposit system 10 is configured by the vending machine 11, the collation device 12, and the collecting machine 13 will be described. The deposit system 10 of the present example embodiment may be achieved as a single device by each of the vending machine 11, the collation device 12, and the collecting machine 13.

The vending machine 11 stores products to be sold. The product stored in the vending machine 11 is discharged to a pick-up port if the input amount of money is sufficient when the product is selected. At this time, an amount of money obtained by adding a deposit to the actual product price is set for the product sold from the vending machine 11. For example, when the sales price of the product is 100 yen, 10 yen is added as a deposit. Note that the amount of the deposit is an example, and the amount of the deposit using the deposit system 10 is not limited to 10 yen. Note that the deposit may be exchanged not in cash but in electronic money, points, or the like.

A camera (not illustrated) that captures an image of a product is installed in the pick-up port of the vending machine 11. The camera installed in the vending machine 11 images a container of a product, and generates image data including an image of a part from which object fingerprint data of the container of the product can be extracted. Note that the camera may be installed at any position where the container of the product can be imaged as long as the camera is positioned between a place where the product is stored and the pick-up port instead of the pick-up port of the vending machine 11. In addition, if the object fingerprint data corresponding to the product sold at the time of sale can be specified, a part of the product may be imaged at the timing before the product is stored in the vending machine 11 or the timing when the product is stored in the vending machine 11. In a case where the container of the product is imaged at the timing before the product is stored in the vending machine 11 or the timing when the product is stored in the vending machine 11, a dedicated terminal with a camera or a general-purpose terminal with a camera including a smartphone or a tablet may be used.

For example, when the product is a canned beverage, the object fingerprint data can be generated based on features extracted from image data obtained by imaging the bottom surface of the can. In addition, for example, in a case where the product is a beverage in PET bottles, the object fingerprint data can be generated based on a feature extracted from image data obtained by imaging a lid of a PET bottle. On the bottom of the can and the surface of the PET bottle lid, there are object fingerprints which are different fine patterns for each individual container. By using this object fingerprint, each individual container can be identified. The place where the object fingerprint is extracted from the container is not limited to the bottom of the can or the lid of the PET bottle as long as the object fingerprint can be extracted, and may be another place of the product container.

When generating image data including an image of a part of the container of the product, the vending machine 11 extracts features from the image data and generates object fingerprint data based on the extracted features. The vending machine 11 outputs the generated image data to the collation device 12. Note that the image data may be output from the vending machine 11 to the collation device 12, and the object fingerprint data may be generated on the collation device 12 side.

The collation device 12 acquires the object fingerprint data from the vending machine 11. When acquiring the object fingerprint data of the container of the product, the collation device 12 assigns individual identification information to the object fingerprint data, and stores the object fingerprint data to which the individual identification information is assigned in the database. When configured to acquire image data of a container of products, the collation device 12 extracts features from the acquired image data and generates object fingerprint data of the container based on the extracted features. The collation device 12 assigns individual identification information to the generated object fingerprint data, and stores the object fingerprint data to which the individual identification information is assigned in the database.

In addition, the collation device 12 acquires object fingerprint data from the collecting machine 13. The collation device 12 searches the database and collates the object fingerprint data of the container. When acquiring the image data of the container, the collation device 12 extracts a feature from the image data. The collation device 12 generates object fingerprint data of the container based on the extracted features, searches a database, and collates the object fingerprint data of the container.

When the object fingerprint data of the container matches any of the object fingerprint data stored in the database, the collation device 12 outputs deposit information indicating that the object fingerprint data of the container is stored in the database to the collecting machine 13. The deposit information is information indicating whether the collected container is a deposit target. When the collected container is a deposit target, the deposit information may include a deposit amount. When the object fingerprint data of the container does not match any of the object fingerprint data stored in the database, the collation device 12 outputs deposit information indicating that the object fingerprint data of the container is not stored in the database to the collecting machine 13. When the object fingerprint data of the container to be collated is matched with any of the object fingerprint data stored in the database, the collation device 12 may delete the object fingerprint data of the container from the database at an appropriate timing.

For example, when outputting deposit information indicating that the object fingerprint data of the container is stored in the database to the collecting machine 13, the collation device 12 deletes the object fingerprint data of the container from the database. The collation device 12 may delete the object fingerprint data of the container from the database at a timing when a predetermined period of time set in advance has elapsed.

The collecting machine 13 includes a storage unit for storing a container of a product, and an input port for inputting the container into the storage unit. In addition, the collecting machine 13 has a return port for refunding the deposited amount. When there is a valid deposit in the container input through the input port, the collecting machine 13 refunds the amount deposited in the container. For example, when 10 yen is deposited on the product, the collecting machine 13 refunds the deposit amount of 10 yen. For example, the deposit may be exchanged not in cash but in electronic money, points, or the like.

A camera (not illustrated) that captures an image of the container is installed in an input port of the collecting machine 13. The camera installed in the collecting machine 13 images a portion from which the object fingerprint data is extracted from the container, and generates image data from which the object fingerprint data for the container can be extracted. Note that the camera may be installed at any position where the container can be imaged between the input port and the storage unit instead of the input port of the collecting machine 13.

When generating image data including an image of a part of the container, the collecting machine 13 extracts features from the image data and generates object fingerprint data based on the extracted features. The collecting machine 13 outputs the generated object fingerprint data to the collation device 12. Note that the deposit system 10 may be configured to output image data from the collecting machine 13 to the collation device 12 and generate object fingerprint data on the collation device 12 side.

The collecting machine 13 acquires deposit information from the collation device 12. The collecting machine 13 returns the additional amount of the deposit according to the deposit information acquired from the collation device 12. When the object fingerprint data of the container to be collated is not registered in the database, the collecting machine 13 may cause a display unit (not illustrated) to display that the object fingerprint data of the container is not registered and the container is not a deposit target, or may notify by a notification sound.

[Vending Machine]

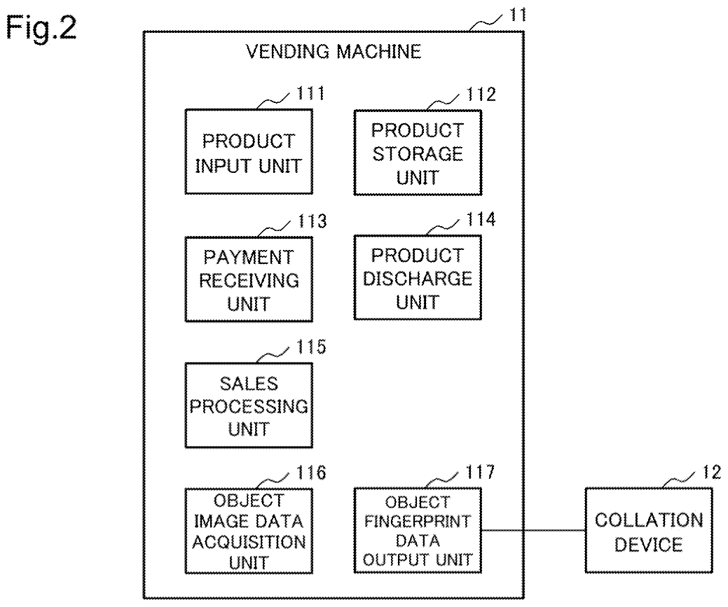

Next, the vending machine 11 included in the deposit system 1 will be described with reference to the drawings. FIG. 2 is a block diagram for describing an example of a configuration of the vending machine 11. The vending machine 11 includes a product input unit 111, a product storage unit 112, a payment receiving unit 113, a product discharge unit 114, a sales processing unit 115, an object image data acquisition unit 116, and an object fingerprint data output unit 117. The product input unit 111, the product storage unit 112, the payment receiving unit 113, and the product discharge unit 114 are installed in a housing of the vending machine 11. The sales processing unit 115, the object image data acquisition unit 116, and the object fingerprint data output unit 117 are achieved by software or a program installed in a computer installed inside a housing of the vending machine 11. The vending machine 11 has a configuration in which a deposit function is added to a general vending machine.

The product input unit 111 is an input port for inputting a product to be sold into the vending machine 11. The product input from the product input unit 111 is stored in the product storage unit 112.

The product storage unit 112 stores products. For example, when the product is a food in a container, a refrigerating function or a heat retaining function may be added to the product storage unit 112. The products stored in the product storage unit 112 are discharged to the product discharge unit 114 according to the sales processing of the sales processing unit 115.

The payment receiving unit 113 receives the payment of the product. In a case where the payment is received with coins or paper money, the payment receiving unit 113 is an input unit for inputting money of coins or paper money. The money input from the payment receiving unit 113 is stored in a money storage unit (not illustrated) inside the vending machine 11. The money stored in the money storage unit (not illustrated) is paid as change or collected as sales money. In a case where a payment is accepted by electronic payment such as electronic money, the payment receiving unit 113 is achieved by a card reader that reads electronic payment information. The deposit information received by the payment receiving unit 113 is output to the sales processing unit 115.

The products stored in the product storage unit 112 are discharged to the product discharge unit 114 according to the sales processing of the sales processing unit 115. A camera (not illustrated) for imaging a part of the container of the product is arranged in the product discharge unit 114. The camera may be installed at any position between the product storage unit 112 and the product discharge unit 114. In addition, only one camera may be installed, or a plurality of cameras may be installed. When the camera is disposed outside the housing of the vending machine 11, there is a possibility that a product not sold by the vending machine 11 is imaged. That is, there is a possibility that a product that is not originally a deposit target is illegally set as a deposit target. Therefore, the camera is preferably disposed inside the housing of the vending machine 11.

The sales processing unit 115 executes the sales processing of the product selected by a selection button (not illustrated) according to the deposit amount received by the payment receiving unit 113. If the deposit amount is sufficient when a product selection button (not illustrated) is selected, the sales processing unit 115 executes sales processing of discharging the product from the product storage unit 112 to the product discharge unit 114. At this time, an amount of money obtained by adding a deposit to the actual product price is set for the product sold from the vending machine 11. The price of the product including the deposit may be exchanged not in cash but in electronic money, points, or the like. An amount obtained by subtracting the sales price of the discharged product from the deposited amount is paid as change.

The object image data acquisition unit 116 causes a camera (not illustrated) installed in the product storage unit 112 to image a part of the container of the product until the product is discharged from the product storage unit 112 to the product discharge unit 114, and generates image data of the container of the product. The object image data acquisition unit 116 extracts features from the generated image data and generates object fingerprint data based on the extracted features. When the image data is output to the collation device 12, the extraction of the object fingerprint data is omitted.

The object fingerprint data output unit 117 outputs the object fingerprint data extracted from the image of a part of the container of the product to the collation device 12. When outputting the image data to the collation device 12, the object fingerprint data output unit 117 outputs the image data to the collation device 12.

[Collation Device]

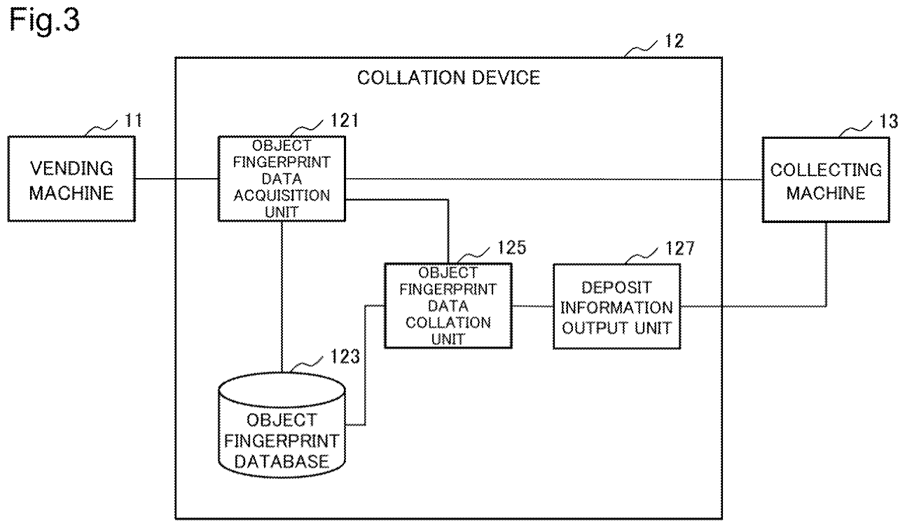

Next, the collation device 12 included in the deposit system 1 will be described with reference to the drawings. FIG. 3 is a block diagram for describing an example of a configuration of the collation device 12. The collation device 12 includes an object fingerprint data acquisition unit 121, an object fingerprint database 123, an object fingerprint data collation unit 125, and a deposit information output unit 127.

The object fingerprint data acquisition unit 121 acquires object fingerprint data from the vending machine 11 and the collecting machine 13. The object fingerprint data acquisition unit 121 stores the object fingerprint data acquired from the vending machine 11 in the object fingerprint database 123. In addition, the object fingerprint data acquisition unit 121 stores the object fingerprint data acquired from the collecting machine 13 in the object fingerprint database 123. When the image data is transmitted and acquired, the object fingerprint data acquisition unit 121 extracts the object fingerprint data from the acquired image data.

The object fingerprint database 123 stores object fingerprint data to which individual identification information is assigned. The object fingerprint database 123 may store object fingerprint data acquired from a container of a product at the time of selling the product from the vending machine 11, or may store object fingerprint data acquired in advance from a container of a product to be sold.

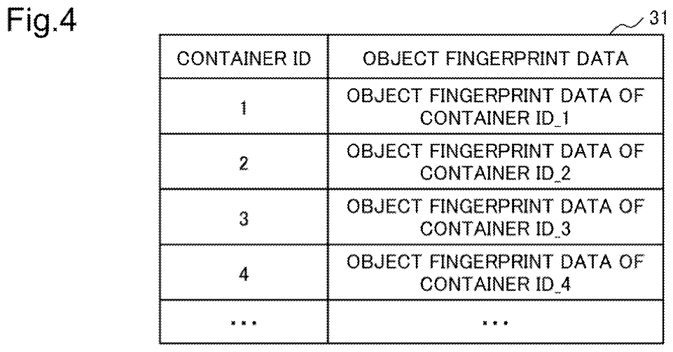

For example, in the object fingerprint database 123, object fingerprint data to which individual identification information is assigned is stored in the form of a table. FIGS. 4 to 6 are tables illustrating an example of the object fingerprint data table stored in the object fingerprint database 123. Note that the object fingerprint data tables of FIGS. 4 to 6 are examples, and the object fingerprint data stored in the object fingerprint database 123 is not limited to the format of the tables illustrated in FIGS. 4 to 6.

FIG. 4 is an object fingerprint data table 31 in which a container ID (individual identification information) and object fingerprint data are associated (ID: Identifier). In practice, the object fingerprint data is numerical data or binary data. Even if there is no container ID, it is also possible to perform individual identification only with object fingerprint data. Therefore, the container ID may be omitted, and only the object fingerprint data may be stored in the object fingerprint database 123.

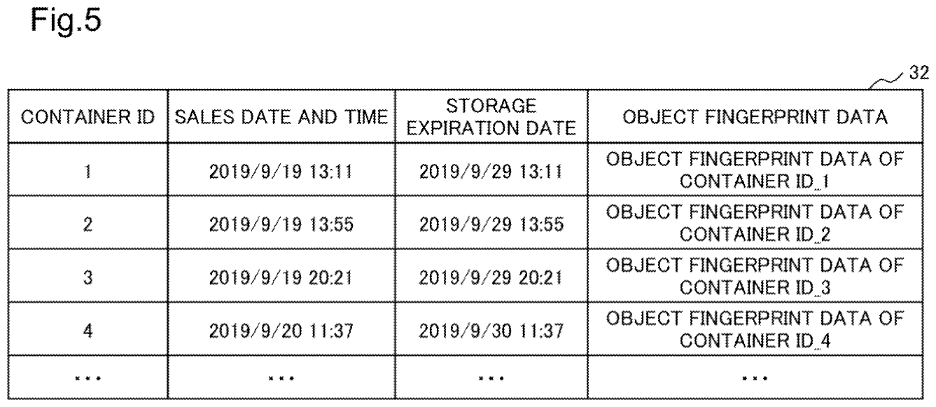

The object fingerprint data may be associated with information related to date and time. FIG. 5 illustrates the object fingerprint data table 32 in which the container ID and the object fingerprint data are associated with a sales date and time of the product corresponding to the object fingerprint data and a storage expiration date (also referred to as a deposit expiration date) of the object fingerprint data. For example, the deposit expiration date is calculated from the sales date and time of the product. For example, a storage period of the object fingerprint data is set to 10 days, and the object fingerprint data that has passed the storage expiration date is deleted. If the storage expiration date of the object fingerprint data is set to a return expiration date of the deposit, it is expected that the possibility that a consumer who has purchased the product collects the container in the collecting machine 13 for returning the deposit is improved. Note that the object fingerprint data table 32 may include a deposit expiration date in addition to the sales date and time of the product or instead of the sales date and time of the product. Further, the deposit expiration date is not limited to the above-mentioned expiration date, and may be appropriately determined according to various conditions such as characteristics of a product and collectability of a container.

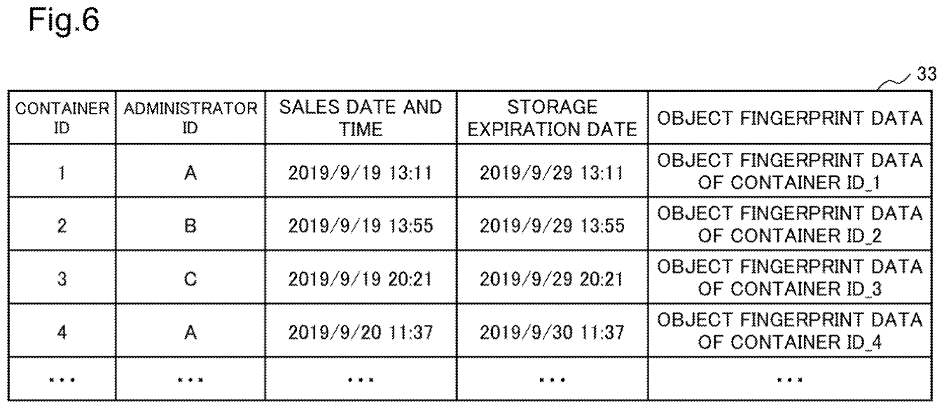

FIG. 6 illustrates an object fingerprint data table 33 in which a container ID and object fingerprint data are associated with an administrator ID (also referred to as management identification information) of the vending machine 11 in addition to a sales date and time of a product from which the object fingerprint data is extracted and a storage expiration date of the object fingerprint data. If the administrator ID is associated with the object fingerprint data, even when the administrators of the vending machine 11 and the collecting machine 13 are different, deposits of the vending machine 11 and the collecting machine 13 can be integrally managed. For example, in a case where there are a vending machine 11 and a collecting machine 13 with different administrators, and a deposit target product purchased at the vending machine 11 of a certain administrator is collected by the collecting machine 13 of another administrator, an event in which a deposit for the product is not paid occurs because the administrator of the product seller and the administrator of the container collection destination are different. The deposit target product (container) is a product (container) to which a deposit is added at the time of sale and to which the added deposit is to be returned when the product is collected by the collecting machine 13. By associating the administrator ID with the object fingerprint data of the deposit target product, it is possible to share the return rule of the deposit between the administrators and collectively manage the deposit payment of each administrator by a host system. The purchaser of the product can receive the return of the deposit from any collecting machine with a different administrator.

The object fingerprint data collation unit 125 acquires the object fingerprint data from the collecting machine 13 from the object fingerprint data acquisition unit 121. When acquiring the object fingerprint data, the object fingerprint data collation unit 125 searches the object fingerprint database 123 and collates the acquired object fingerprint data.

When the object fingerprint data of the container matches any object fingerprint data stored in the object fingerprint database 123, the object fingerprint data collation unit 125 generates deposit information indicating that the object fingerprint data of the container is stored in the object fingerprint database 123. The object fingerprint data collation unit 125 outputs the generated deposit information to the deposit information output unit 127.

When outputting the deposit information to the deposit information output unit 127, the object fingerprint data collation unit 125 deletes the object fingerprint data corresponding to the deposit information from the object fingerprint database 123. For example, the object fingerprint data collation unit 125 deletes the object fingerprint data corresponding to the deposit information from the object fingerprint database 123 in accordance with the timing of outputting the deposit information to the deposit information output unit 127. For example, the object fingerprint data collation unit 125 deletes the object fingerprint data corresponding to the deposit information from the object fingerprint database 123 in accordance with the timing at which the deposit information output unit 127 outputs the deposit information.

The object fingerprint data collation unit 125 deletes the object fingerprint data from the object fingerprint database 123 at a timing when a preset deposit period has elapsed. For example, when a storage period of the object fingerprint data is set to 10 days, the object fingerprint data collation unit 125 deletes the object fingerprint data that has passed the storage period (10 days). The timing at which the object fingerprint data of the container is deleted from the object fingerprint database 123 may be set in accordance with the timing at which the deposit information is output to the collecting machine 13.

When the object fingerprint data of the container does not match any object fingerprint data stored in the object fingerprint database 123, the object fingerprint data collation unit 125 generates deposit information indicating that the container is a deposit target. For example, when a container input into the collecting machine 13 is not stored in the object fingerprint database 123, information indicating that the container is not a deposit target or information indicating that the deposit return expiration date has passed may be displayed on the collecting machine 13.

The deposit information output unit 127 acquires deposit information from the object fingerprint data collation unit 125. The deposit information output unit 127 outputs the acquired collation result to the collecting machine 13.

[Collecting Machine]

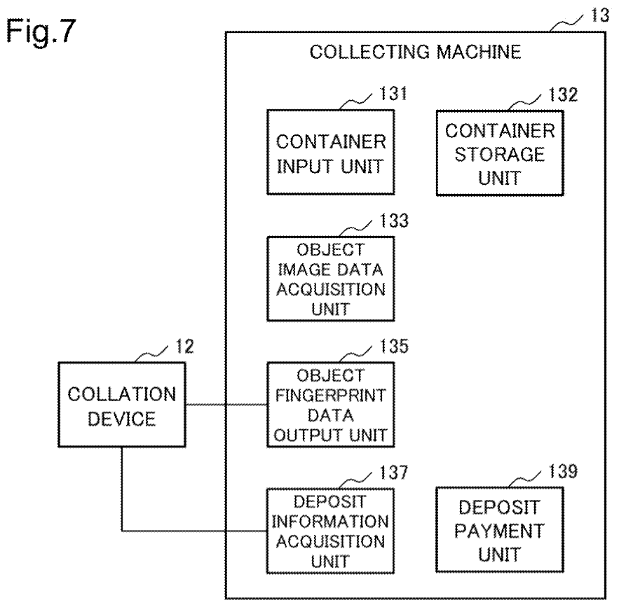

Next, the collecting machine 13 included in the deposit system 1 will be described with reference to the drawings. FIG. 7 is a block diagram for describing an example of a configuration of the collecting machine 13. The collecting machine 13 includes a container input unit 131, a container storage unit 132, an object image data acquisition unit 133, an object fingerprint data output unit 135, a deposit information acquisition unit 137, and a deposit payment unit 139. The container input unit 131 and the container storage unit 132 are installed in a housing of the collecting machine 13. The object image data acquisition unit 133, the object fingerprint data output unit 135, the deposit information acquisition unit 137, and the deposit payment unit 139 are achieved by software or a program installed in a computer installed inside a housing of the collecting machine 13.

The container input unit 131 is an input port for a container to be collected. A container is input into the container input unit 131. The container input into the container input unit 131 is stored in the container storage unit 132. A camera (not illustrated) for imaging the container is installed in the container input unit 131. Note that the camera may be installed at any position as long as the camera can image the container between the container input unit 131 and the container storage unit 132, instead of the container input unit 131.

The collected containers are stored in the container storage unit 132. Generally, a bag for housing a container is installed inside the container storage unit 132, and the container is stored inside the bag. For example, the containers stored in the container storage unit 132 are collected for recycling or reuse.

The object image data acquisition unit 133 causes a camera (not illustrated) installed in the container input unit 131 to image a part of the container, and generates image data including an image of the part of the container. The object image data acquisition unit 133 extracts features from the generated image data and generates object fingerprint data based on the extracted features. When the image data is output to the collation device 12, the object image data acquisition unit 133 can omit extraction of the object fingerprint data.

The object fingerprint data output unit 135 outputs the object fingerprint data extracted from the image of the part of the collected container to the collation device 12. When outputting the image data to the collation device 12, the object fingerprint data output unit 135 outputs the image data to the collation device 12.

The deposit information acquisition unit 137 acquires deposit information from the collation device 12. The deposit information acquisition unit 137 outputs the deposit information acquired from the collation device 12 to the deposit payment unit 139.

The deposit payment unit 139 acquires deposit information from the deposit information acquisition unit 137. The deposit payment unit 139 executes processing of paying a deposit according to the acquired deposit information. The deposit payment unit 139 pays an amount of money corresponding to the deposit to a return port (not illustrated) for refunding the deposit. When the deposit of the container input from the container input unit 131 is valid, the amount of money deposited in the container is refunded. For example, in a case where 10 yen is deposited on the product, 10 yen is refunded. In addition, the deposit may be exchanged not in cash but in electronic money, points, or the like. When the deposit of the container input from the container input unit 131 is valid, a point may be granted to electronic money, a point card, or the like in addition to the deposit amount. In addition, in a case where the object fingerprint data corresponding to the object fingerprint data of the container to be collated is not registered in the database, the deposit payment unit 139 may be configured to cause a display unit (not illustrated) to display or notify that the object fingerprint data of the container is not registered.

(Operation)

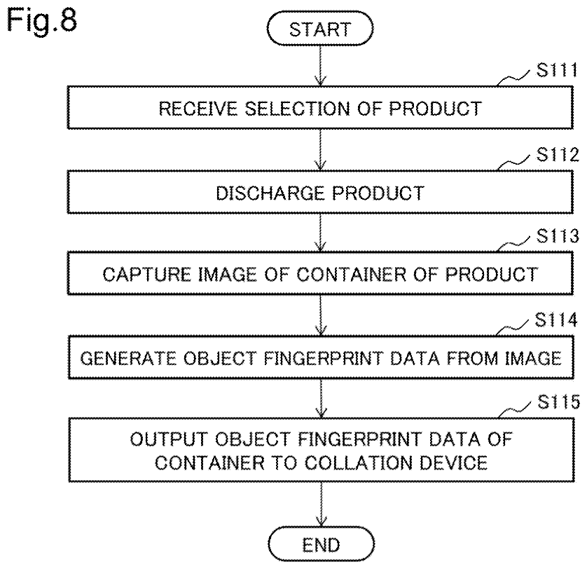

Next, an operation of the deposit system 10 will be described with reference to the drawings. FIGS. 8 to 11 are flowcharts for explaining the operation of the deposit system 10. Hereinafter, the operation of the components of the deposit system 10 will be described separately for when the product is sold and when the container is collected.

[At the Time of Product Sale]

FIG. 8 is a flowchart for explaining the operation of the vending machine 11 at the time of selling a product.

In FIG. 8, first, the sales processing unit 115 receives selection of a product via a product selection button (not illustrated) installed in the housing (step S111).

At this time, if money equal to or more than the amount of money of the selected product is input, the sales processing unit 115 discharges the product to the product discharge unit 114 (step S112). However, it is assumed that a deposit is added to the amount of money of the selected product.

Next, the object image data acquisition unit 116 causes a camera (not illustrated) to image a part of the product discharged to the product discharge unit 114, and generates image data (step S113).

Next, the object image data acquisition unit 116 extracts features from the image data and generates object fingerprint data based on the extracted features (step S114).

Then, the object fingerprint data output unit 117 outputs the object fingerprint data extracted from the image data generated by the object image data acquisition unit 116 to the collation device 12 (step S115). When the image data is output, step S114 is omitted, and the image data is output to collation device 12 in step S115.

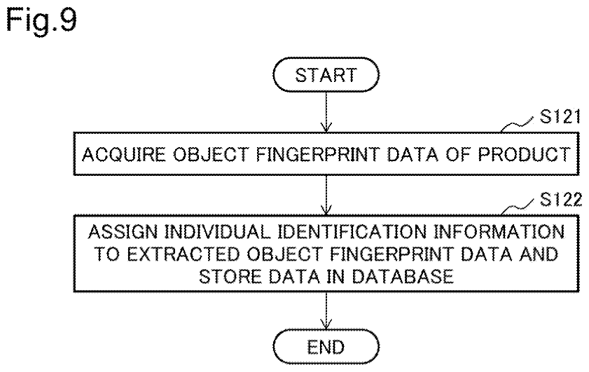

FIG. 9 is a flowchart for explaining the operation of the collation device 12 at the time of selling a product. Hereinafter, the components (see FIG. 3) of the collation device 12 will be described as the operation subject, but the deposit system 10 and the collation device 12 can also be regarded as the operation subject.

In FIG. 9, first, the object fingerprint data acquisition unit 121 acquires object fingerprint data from the vending machine 11 (step S121). When image data is acquired, the object fingerprint data acquisition unit 121 extracts features from the acquired image data and generates object fingerprint data based on the extracted features.

Next, the object fingerprint data acquisition unit 121 assigns individual identification information to the object fingerprint data and stores the data in the object fingerprint database 123 (step S123).

[During Collection of Container]

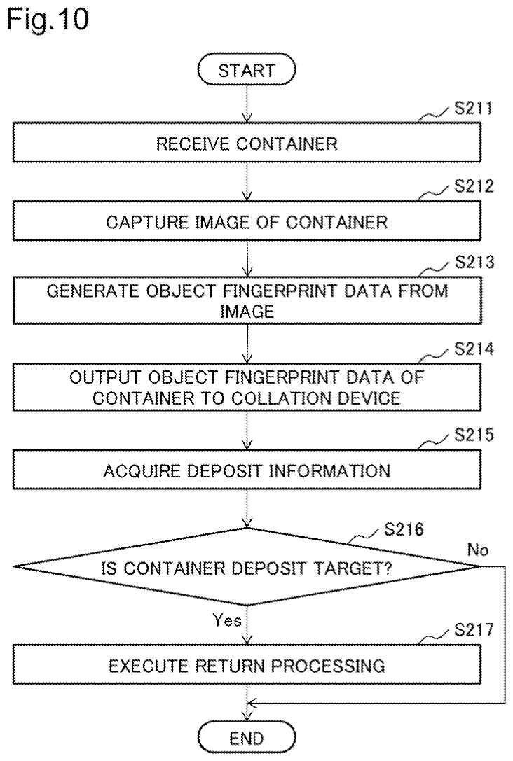

FIG. 10 is a flowchart for explaining the operation of the collecting machine 13 at the time of collecting the container.

In FIG. 10, first, the container input unit 131 receives an input container (step S211).

Next, the object image data acquisition unit 133 causes a camera (not illustrated) installed in the container input unit 131 to image a part of the container to generate image data (step S212).

Next, the object image data acquisition unit 133 extracts features from the image data and generates object fingerprint data based on the extracted features (step S213).

Next, the object fingerprint data output unit 135 outputs the object fingerprint data generated by the object image data acquisition unit 133 to the collation device 12 (Step S214). When the image data is output, step S213 is omitted, and the image data is output to collation device 12 in step S214.

In addition, the object fingerprint data output unit 135 acquires deposit information of the container input to the container input unit 131 from the collation device 12 (step S215).

When the container input into the container input unit 131 is a deposit target (Yes in step S216), the deposit payment unit 139 executes deposit return processing (step S217). On the other hand, when the container input into the container input unit 131 is not a deposit target (No in step S216), the deposit payment unit 139 does not execute deposit return processing.

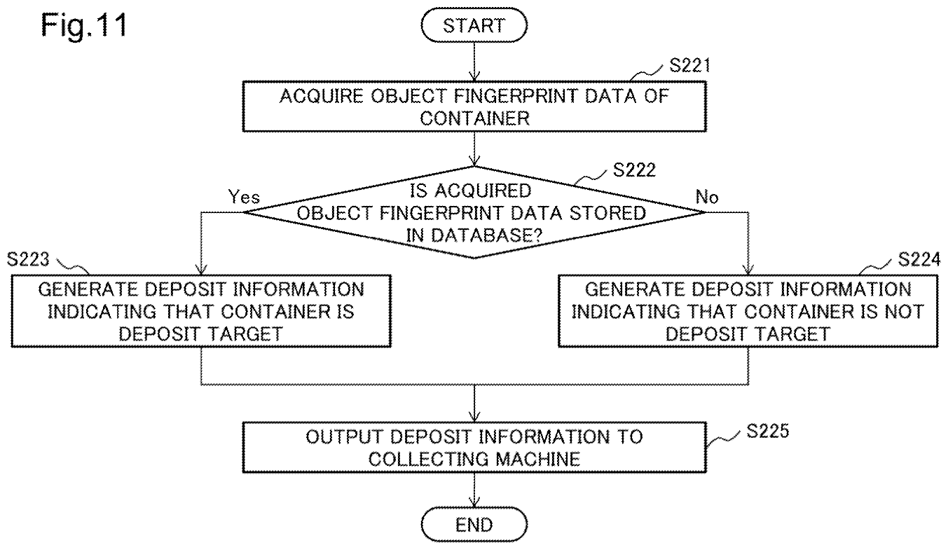

FIG. 11 is a flowchart for explaining the operation of the collation device 12 at the time of collecting the container. The processing along the flowchart of FIG. 11 is executed between step S213 and step S214 of FIG. 10.

In FIG. 11, first, the object fingerprint data acquisition unit 121 acquires object fingerprint data extracted from the container collected by the collecting machine 13 (step S221). When image data is acquired, the object fingerprint data acquisition unit 121 extracts features from the acquired image data and generates object fingerprint data based on the extracted features.

Here, the object fingerprint data collation unit 125 searches the object fingerprint database 123 and collates the acquired object fingerprint data (step S222). When the object fingerprint data is stored in the object fingerprint database 123 (Yes in step S222), the object fingerprint data collation unit 125 generates deposit information indicating that the collected container is a deposit target (step S223). Then, the deposit information output unit 127 outputs deposit information indicating that the collected container is a deposit target to the collecting machine 13 (step S225).

On the other hand, when the object fingerprint data is not stored in the object fingerprint database 123 (No in step S222), the deposit information output unit 127 generates deposit information indicating that the collected container is not a deposit target (step S224). Then, the deposit information output unit 127 outputs deposit information indicating that the collected container is not a deposit target to the collecting machine 13 (step S225).

As described above, the deposit system of the present example embodiment includes the vending machine, the collation device, and the collecting machine. The vending machine generates image data of the deposit target product, and outputs the generated image data of the deposit target product to the collation device. The collecting machine generates object fingerprint data from the image data of the collation target container, and outputs the generated object fingerprint data to the collation device. The collecting machine acquires deposit information on the object fingerprint data of the collation target container from the collation device, and returns the deposit based on the deposit information.

A collation device according to an aspect of the present example embodiment includes an object fingerprint database, an object fingerprint data acquisition unit, an object fingerprint data collation unit, and a deposit information output unit. The object fingerprint data extracted from the image data of the deposit target product is stored in the object fingerprint database. The object fingerprint data acquisition unit acquires object fingerprint data extracted from the image data of the container. The object fingerprint data collation unit collates the object fingerprint data extracted from the image data of the container with the object fingerprint data stored in the object fingerprint database, and generates deposit information according to the collation result. The deposit information output unit outputs the deposit information generated by the object fingerprint data collation unit to an output source of the object fingerprint data.

In the present example embodiment, it is not necessary to spray a paint as a mark for individual identification on a product. In addition, in the present example embodiment, it is not necessary to attach a seal, an RFID Tag, or the like serving as a mark for individual identification to a product. That is, according to the present example embodiment, it is possible to collate whether an individual container is a deposit target at the time of collecting the container without attaching a mark in advance.

In one aspect of the present example embodiment, the object fingerprint data acquisition unit acquires object fingerprint data extracted from the image data of the collation target container. The object fingerprint data collation unit collates the object fingerprint data extracted from the image data of the collation target container with the object fingerprint data stored in the object fingerprint database.

In one aspect of the present example embodiment, the object fingerprint data acquisition unit acquires the object fingerprint data extracted from the image data of the deposit target product. The object fingerprint data acquisition unit stores the object fingerprint data extracted from the image data of the deposit target product in the object fingerprint database in association with the individual identification information.

For example, the object fingerprint data acquisition unit stores the object fingerprint data extracted from the image data of the deposit target product in the object fingerprint database in association with the deposit expiration date of the deposit target product. This is because it may be costly to hold the object fingerprint data for a long period of time, and thus it is better to provide a storage expiration date (deposit expiration date) of the object fingerprint data. In order to prevent a product from being sold in a state where the deposit expiration date has passed, it is preferable that the deposit expiration date be set starting from the time when the target product is sold.

The object fingerprint data acquisition unit may store the management identification information of the deposit target product in the object fingerprint database in association with the object fingerprint data extracted from the image data of the deposit target product. If the management identification information of the deposit target product is stored in the object fingerprint database in association with each other, it is possible to construct a deposit system capable of collectively managing a plurality of vending machines and collecting machines on the server side and refunding deposits from any collecting machine.

The deposit system of the present example embodiment may acquire personal identification information of the user who has input the collation target container into the collecting machine, and assign a point to the personal identification information of the user based on the deposit returned from the collecting machine.

In the system for paying out deposits based only on the object fingerprint data extracted from the containers collected by the collecting machine, it has not been possible to specify which vending machine sold the product to whose empty container belongs. Therefore, such a system relies on trust and conscience to collect containers, and it is difficult to install the system in a place used by an unspecified number of people. From such a background, a system for collecting a container and paying out a deposit has been difficult to spread. According to the present example embodiment, it is possible to identify the containers of individual products at the time of selling the products and collate the individual containers at the time of collecting the containers, and thus, it is possible to install a system for collecting the containers and paying out deposits at a place widely used by an unspecified large number of people.

For example, the method of the present example embodiment can also be applied to an application-linked service that assigns a point to personal identification information of a user who has answered a questionnaire regarding a product when the container of the product is collected. Such an application-linked service can also be applied to electronic money, card payment, and the like.

According to the method of the present example embodiment, the present invention can also be applied to an application of tracking where a product is bought and where a container of the product is collected. For example, by using the method of the present example embodiment, it is possible to track where a container of a beverage sold at a departure home of the Shinkansen has been collected. As described above, by tracking the collection destination of the container, it is possible to investigate not only the getting-on/off record of the Shinkansen but also how far the passenger has gone after getting off the Shinkansen. For example, if a vending machine that sells a beverage purchased by the passenger is installed at a collection destination of the container, there is a possibility that the beverage is purchased.

The method of the present example embodiment can be applied not only to collection for recycling containers but also to collection for reusing containers. For example, when the method of the present example embodiment is applied to collection of a beer bottle, a liquor bottle, a liquor circulation box, and the like, an empty bottle fee and a distribution fee can be received without directly visiting a store.

The method of the present example embodiment can also be applied to collection of rental items. For example, if the method of the present example embodiment is applied to return a rental item such as a videotape, even after the store is closed, if the rental item is returned to the collecting machine arranged outside the store by the return deadline, the occurrence of the penalty can be eliminated. In addition, for example, when the method of the present example embodiment is applied to return a rental bicycle, an umbrella, or the like, it is possible to prevent the bicycle or the umbrella from being left at a place other than a return place.

### Application Example

Next, an application example of the deposit system of the present example embodiment will be described with reference to the drawings. The following application example is an example of a configuration in which a vending machine and a collecting machine managed by a plurality of administrators are collectively managed by a collation device or a management device arranged in a server or a cloud.

### Application Example 1

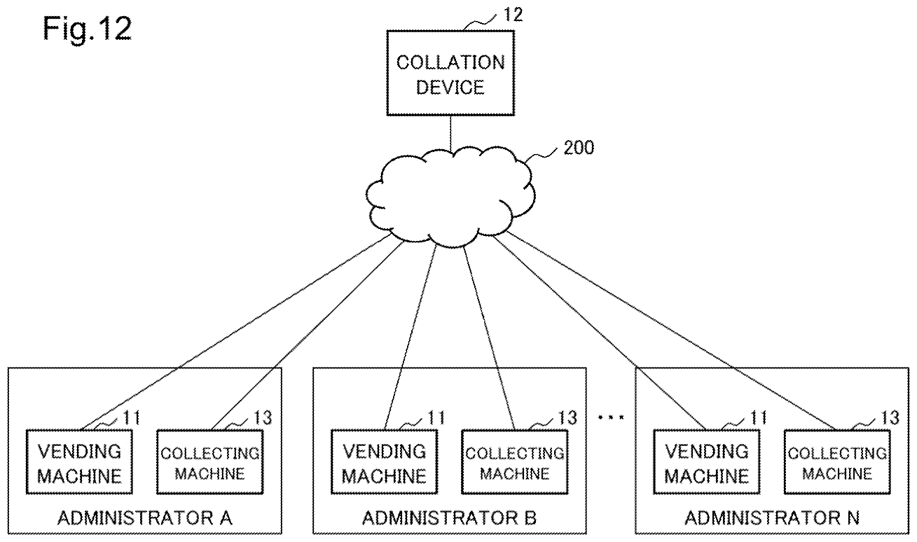

FIG. 12 is a block diagram illustrating an example of a configuration of a deposit system of Application Example 1. Application Example 1 is an example in which the vending machine 11 and the collecting machine 13 managed by a plurality of administrators (administrator A, administrator B, . . . , administrator N) are collectively managed by the collation device 12 arranged in a server or a cloud via the network 200. In FIG. 12, the same reference numerals are given to the vending machine 11 and the collecting machine 13 even when the administrators are different. Each of the plurality of administrators may manage a plurality of the vending machines 11 and the collecting machines 13.

The collation device 12 stores the object fingerprint data of the containers of the products sold by the plurality of vending machines 11 with different administrators in the object fingerprint database 123 (see FIG. 3). At this time, the collation device 12 acquires the object fingerprint data associated with the administrator ID. The collation device 12 stores the object fingerprint data associated with the administrator ID in the object fingerprint database 123 as in the object fingerprint data table 33 of FIG. 6.

When acquiring the object fingerprint data from any of the collecting machines 13, the collation device 12 searches the object fingerprint database 123. When detecting the object fingerprint data matching the object fingerprint data acquired from the collecting machine 13 from the object fingerprint database 123, the collation device 12 generates deposit information indicating that the container from which the object fingerprint data is extracted is a deposit target. The collation device 12 outputs the generated deposit information to the collecting machine 13 which is an output source of the object fingerprint data.

When acquiring the deposit information from the collation device 12, the collecting machine 13 pays the deposit according to the deposit information. The balance of deposits paid from the collecting machine 13 may be adjusted among administrators. For example, when a container of a product sold by the vending machine 11 of the administrator A is collected by the collecting machine 13 of the administrator B and a deposit is paid from the collecting machine 13 of the administrator B, the administrator B pays the deposit of the administrator A instead. In such a case, billing information corresponding to the deposit may be sent from the administrator B to the administrator A, and the administrator A corresponding to the billing information may remit money to the administrator B.

In the present application example, even when the administrators of the vending machine and the collecting machine are different, the deposit information can be shared between the administrators. According to the present application example, even when an administrator of the vending machine of the product purchase source is different from an administrator of the collection container of the container collection destination, the deposit can be paid out by the collection container of the container collection destination. Therefore, according to the present application example, convenience for consumers who use the deposit system can be improved.

### Application Example 2

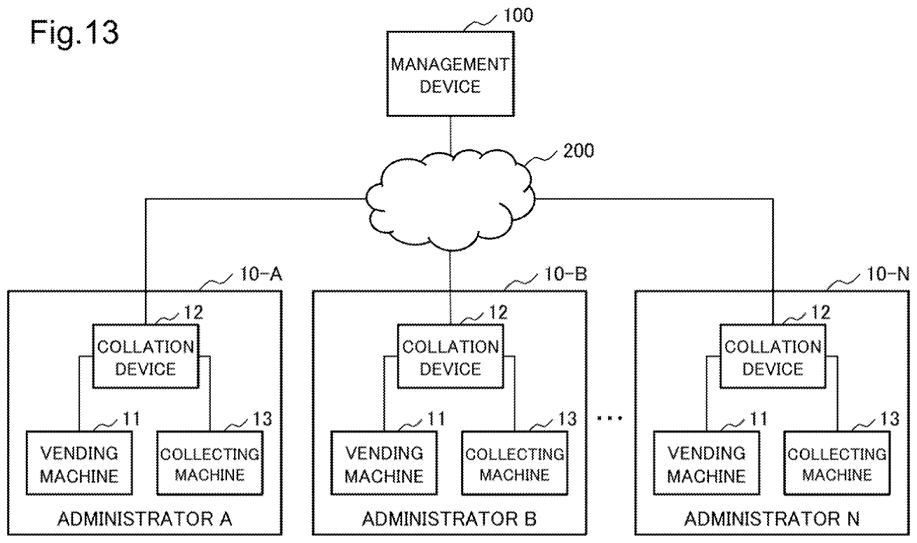

FIG. 13 is a block diagram illustrating an example of a configuration of a deposit system of Application Example 2. Application Example 2 is an example in which the deposit system 10 (10-A, 10-B, . . . , 10-N) managed by a plurality of administrators (administrator A, administrator B, . . . , administrator N) is collectively managed by the management device 100 via the network 200. The management device 100 is disposed in a server or a cloud. The management device 100 has a collation function similar to that of the collation device 12. In FIG. 13, the vending machine 11, the collation device 12, and the collecting machine 13 are denoted by the same reference numerals even if the administrator is different. Each of the plurality of administrators may manage a plurality of the vending machines 11 and the collecting machines 13.

The collation device 12 stores the object fingerprint data of the containers of the products sold by the plurality of vending machines 11 with different administrators in the object fingerprint database 123 (see FIG. 3). At this time, the collation device 12 stores the object fingerprint data associated with the administrator ID (also referred to as management identification information) in the object fingerprint database 123. The collation device 12 stores the object fingerprint data associated with the administrator ID in the object fingerprint database 123 as in the object fingerprint data table 33 of FIG. 6.

In addition, the collation device 12 outputs the object fingerprint data stored in the object fingerprint database 123 of the collation device 12 to the management device 100 in association with the administrator ID. In Application Example 2, the object fingerprint data associated with the administrator ID of each of the plurality of deposit systems 10 is stored in a database (not illustrated) of the management device 100.

When the collation device 12 included in each of the plurality of deposit systems 10 acquires the object fingerprint data from the collecting machine 13 included in the system, the collation device 12 refers to the object fingerprint database 123 and searches for the extracted object fingerprint data.

When the object fingerprint data acquired from the collecting machine 13 matches any of the object fingerprint data stored in the object fingerprint database 123, the collation device 12 generates deposit information indicating that the container from which the object fingerprint data is extracted is a deposit target. The collation device 12 outputs deposit information to the collecting machine 13 which is an output source of the object fingerprint data. On the other hand, when the object fingerprint data acquired from the collecting machine 13 does not match any of the object fingerprint data stored in the object fingerprint database 123, the collation device 12 generates deposit information indicating that the container from which the object fingerprint data is extracted is not a deposit target.

When acquiring the object fingerprint data from any of the deposit systems 10, the management device 100 refers to a database (not illustrated) of the management device 100 and searches for the acquired object fingerprint data.

When the acquired object fingerprint data is detected from the database, the management device 100 generates deposit information indicating that the container from which the object fingerprint data is extracted is a deposit target. The management device 100 outputs deposit information to the deposit system 10 that is an output source of the object fingerprint data. On the other hand, when the acquired object fingerprint data is not detected from the database, the management device 100 outputs deposit information indicating that the object fingerprint data is not detected from the database to the deposit system 10 as an output source of the object fingerprint data.

When acquiring the deposit information from the management device 100, the collation device 12 included in each of the plurality of deposit systems 10 outputs the deposit information to the collecting machine 13 included in the system. When acquiring the deposit information from the collation device 12, the collecting machine 13 that has acquired the deposit information pays the deposit corresponding to the deposit information. The balance of deposits paid from the collecting machine 13 may be adjusted among administrators. For example, in a case where a container of a product sold by the vending machine 11 of the administrator A is collected by the collecting machine 13 of the administrator B and a deposit is paid, transaction data corresponding to the amount of the deposit may be remitted from the administrator B to the administrator A.

In the present application example, similarly to Application Example 1, even when the administrators of the vending machine and the collecting machine are different, the deposit information can be shared between the administrators. According to the present application example, even when an administrator of the vending machine of the product purchase source is different from an administrator of the collection container of the container collection destination, the deposit can be paid out by the collection container of the container collection destination. Further, according to the present application example, when the same administrator is employed, the collation processing and the deposit refund processing can be completed in the deposit system 10 of the administrator. Therefore, according to the present application example, the processing can be simplified as compared with Application Example 1.

As described above, according to Application Example 1 and Application Example 2, it is possible to construct a system in which a plurality of vending machines and collecting machines are collectively managed on the server side, and deposits can be refunded from any collecting machine.

(Hardware)

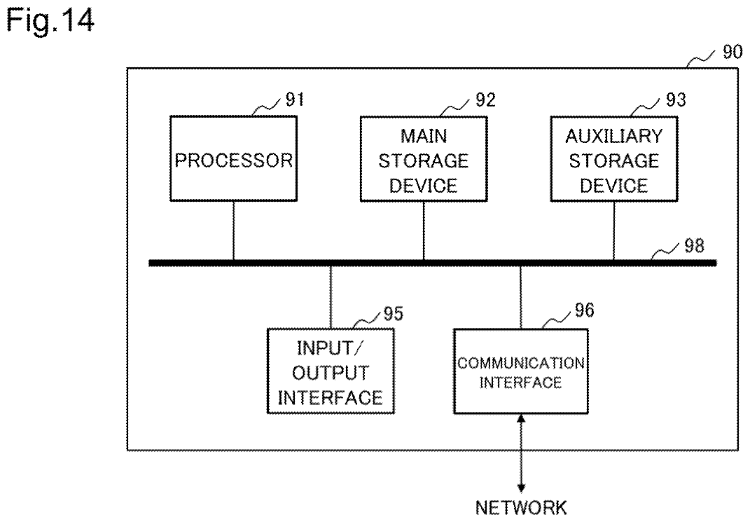

Here, a hardware configuration for achieving processing by the deposit system according to the example embodiment will be described using an information processing device 90 of FIG. 14 as an example. For example, the information processing device 90 achieves processing by the sales processing unit 115, the object image data acquisition unit 116, and the object fingerprint data output unit 117 included in the vending machine 11. For example, the information processing device 90 achieves processing by the collation device 12. For example, the information processing device 90 achieves processing of the object image data acquisition unit 133, the object fingerprint data output unit 135, and the deposit information acquisition unit 137 included in the collecting machine 13. Note that the information processing device 90 in FIG. 14 is a configuration example for achieving processing by the deposit system of the example embodiment, and does not limit the scope of the present invention.

As illustrated in FIG. 14, the information processing device 90 includes a processor 91, a main storage device 92, an auxiliary storage device 93, an input/output interface 95, and a communication interface 96. In FIG. 14, the interface is abbreviated as an I/F. The processor 91, the main storage device 92, the auxiliary storage device 93, the input/output interface 95, and the communication interface 96 are data-communicably connected to each other via a bus 98. In addition, the processor 91, the main storage device 92, the auxiliary storage device 93, and the input/output interface 95 are connected to a network such as the Internet or an intranet via the communication interface 96.

The processor 91 deploys the program stored in the auxiliary storage device 93 or the like in the main storage device 92 and executes the deployed program. In the present example embodiment, a software program installed in the information processing device 90 may be used. The processor 91 executes processing by the deposit system according to the present example embodiment. For example, the processor 91 is achieved by a central processing unit (CPU). The processor 91 may be achieved by a graphics processing unit (GPU) or may be achieved by a combination of a CPU and a GPU. The processor 91 may be singular or plural. When there are a plurality of processors 91, the processors may be mounted on a single substrate or may be distributed on a plurality of substrates or servers.

The main storage device 92 has an area in which a program is deployed. The main storage device 92 may be a volatile memory such as a dynamic random access memory (DRAM). In addition, a non-volatile memory such as a magnetoresistive random access memory (MRAM) may be configured and added as the main storage device 92.

The auxiliary storage device 93 stores various data. The auxiliary storage device 93 includes a local disk such as a hard disk or a flash memory. Note that various data may be stored in the main storage device 92, and the auxiliary storage device 93 may be omitted.

The input/output interface 95 is an interface for connecting the information processing device 90 and a peripheral device. The communication interface 96 is an interface for connecting to an external system or device through a network such as the Internet or an intranet based on a standard or a specification. The input/output interface 95 and the communication interface 96 may be shared as an interface connected to an external device.

An input device such as a keyboard, a mouse, or a touch panel may be connected to the information processing device 90 as necessary. These input devices are used to input information and settings. When the touch panel is used as the input device, the display screen of the display device may also serve as the interface of the input device. Data communication between the processor 91 and the input device may be mediated by the input/output interface 95.

Furthermore, the information processing device 90 may be provided with a display device for displaying information. In a case where a display device is provided, the information processing device 90 preferably includes a display control device (not illustrated) for controlling display of the display device. The display device may be connected to the information processing device 90 via the input/output interface 95.

Furthermore, a drive device that mediates reading of data and a program from a recording medium (not illustrated), writing of a processing result of the information processing device 90 to the recording medium, and the like between the processor 91 and the recording medium (program recording medium) may be added to the information processing device 90. The recording medium can be achieved by, for example, an optical recording medium such as a compact disc (CD) or a digital versatile disc (DVD). Furthermore, the recording medium may be achieved by a semiconductor recording medium such as a universal serial bus (USB) memory or a secure digital (SD) card, a magnetic recording medium such as a flexible disk, or another recording medium. When a program executed by the processor is recorded in a recording medium, the recording medium corresponds to a program recording medium.

Note that a program for causing a computer to execute processing related to the deposit system according to each example embodiment is also included in the scope of the present invention. Further, a program recording medium in which the program according to each example embodiment is recorded is also included in the scope of the present invention.

The components of the deposit system of the present example embodiment can be arbitrarily combined. In addition, the components of the deposit system of the present example embodiment may be achieved by software or may be achieved by a circuit.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

### REFERENCE SIGNS LIST

10 deposit system
11 vending machine
12 collation device
13 collecting machine
111 product input unit
112 product storage unit
113 payment receiving unit
114 product discharge unit
115 sales processing unit
116 object image data acquisition unit
117 object fingerprint data output unit
121 object fingerprint data acquisition unit
123 object fingerprint database
125 object fingerprint data collation unit
127 deposit information output unit
131 container input unit
132 container storage unit
133 object image data acquisition unit
135 object fingerprint data output unit
137 deposit information acquisition unit
139 deposit payment unit

What is claimed is:

1. A collation device, comprising:
an object fingerprint database in which first object fingerprint data extracted from first image data of a deposit target product is stored;
one or more memories storing instructions; and
one or more processors configured to execute the instructions to:
acquire second object fingerprint data extracted from second image data of a container;
collate the second object fingerprint data extracted from the second image data of the container with the first object fingerprint data stored in the object fingerprint database and generate deposit information according to a collation result; and
output the deposit information to an output source of the second object fingerprint data.

2. The collation device according to claim 1, wherein
the one or more processors are configured to execute the instructions to:
acquire second image data of a collation target container, and
extract the second object fingerprint data from the second image data of the collation target container, and
output the deposit information indicating that the collation target container is a deposit target when the second object fingerprint data extracted from the second image data of the collation target container matches the first object fingerprint data stored in the object fingerprint database.

3. The collation device according to claim 1, wherein
the one or more processors are configured to
execute the instructions to acquire the first object fingerprint data extracted from the first image data of the deposit target product, and
store the first object fingerprint data in the object fingerprint database in association with individual identification information.

4. The collation device according to claim 3, wherein the one or more processors are configured to execute the instructions to
store the first object fingerprint data extracted from the first image data of the deposit target product in the object fingerprint database in association with a deposit expiration date of the deposit target product.

5. The collation device according to claim 3, wherein
the one or more processors are configured to execute the instructions to
store the first object fingerprint data extracted from the first image data of the deposit target product in the object fingerprint database in association with management identification information of the deposit target product.

6. A deposit system, comprising:
the collation device according to claim 1, and
a collecting machine configured to generate second object fingerprint data from second image data of a collation target container, output the generated second object fingerprint data to the collation device, acquire deposit information on the collation target container from the collation device, and return a deposit based on the deposit information.

7. The deposit system according to claim 6, wherein personal identification information of a user who input the collation target container into the collecting machine is acquired, and a predetermined point is granted to an account associated with the user based on the deposit returned from the collecting machine.

8. The deposit system according to claim 6, further comprising a vending machine configured to generate the first object fingerprint data from the first image data of a deposit target product and output the generated the first object fingerprint data to the collation device.

9. A collation method, executed by a computer, comprising:
acquiring second object fingerprint data extracted from second image data of a container;
collating the second object fingerprint data with first object fingerprint data stored in an object fingerprint database by referring to the object fingerprint database in which the first object fingerprint data is stored, the first object fingerprint data being extracted from first image data of a deposit target product;
generating deposit information according to a collation result; and
outputting deposit information to an output source of the second object fingerprint data.

10. A non-transient program recording medium on which a program is recorded, the program for causing a computer to execute:
acquiring second object fingerprint data extracted from image data of a container;
collating the second object fingerprint data with first object fingerprint data stored in an object fingerprint database by referring to the object fingerprint database in which the first object fingerprint data is stored, the first object fingerprint data being extracted from first image data of a deposit target product;
generating deposit information according to a collation result; and
outputting deposit information to an output source of the second object fingerprint data.
